(19) United States
(12) Patent Application Publication
(10) Pub. No.: US 2026/0242700 A1
(43) Pub. Date: Aug. 20, 2026

(54) LIPASE VARIANTS AND COMPOSITIONS THEREOF

(71) Applicant: THE PROCTER & GAMBLE COMPANY, Cincinnati, OH (US)

(72) Inventors: Lone BAUNSGAARD, Helsingør (DK); Amanda Georgiana BOWES, Newcastle upon Tyne (GB); Lars Lehmann Hylling CHRISTENSEN, Alleroed (DK); Michelle JACKSON, Newcastle upon Tyne (GB); Rolf Thomas LENHARD, Lyngby (DK); Marco MALTEN, Copenhagen (DK); Lene Irene OLSEN, Bagsvaerd (DK); Steven George PATTERSON, Washington Tyne & Wear (GB); Anders Gunnar SANDSTROEM, Södra Sandby (SE); Philip Frank SOUTER, Morpeth (GB); Jesper VIND, Vaerloese (DK)

(21) Appl. No.: 19/529,207

(22) Filed: Feb. 4, 2026

(30) Foreign Application Priority Data
Feb. 6, 2025 (EP) 25156218.7

(51) Int. Cl. C11D 3/386; C11D 1/22; C11D 3/04; C11D 3/37; C11D 3/43; C11D 17/04

(52) U.S. Cl. CPC C11D 3/38627; C11D 1/22; C11D 3/046; C11D 3/3788; C11D 3/38618; C11D 3/43; C11D 17/043

(57) ABSTRACT

A liquid laundry detergent composition, wherein the liquid laundry detergent composition includes from 5% to 45% by weight of the liquid laundry detergent composition of linear alkylbenzene sulfonate, a variant of a parent lipase which variant has lipase activity, has at least 60%, but less than 100% sequence identity with SEQ ID NO: 1 or SEQ ID NO: 2 and comprises the following substitutions: I202C+P253C, and from 2% to 60% by weight of the liquid laundry detergent composition of water.

### REFERENCE TO AN ELECTRONIC SEQUENCE LISTING

The contents of the electronic sequence listing (CM05820FSEQLXML26.xml; Size 5.02 KB (5.148 bytes)); and Date of Creation: Feb. 3, 2026, is hereby incorporated by reference in its entirety.

### FIELD

This disclosure relates to detergent compositions and water-soluble unit dose articles comprising detergent compositions comprising lipase enzymes, as well as methods of using such compositions.

### BACKGROUND

Lipases are important biocatalysts which have been shown to be useful for various applications. Lipases have been commercialized as active ingredients in detergent compositions for the removal of lipid stains by hydrolyzing triglycerides to generate fatty acids. Following hydrolysis the hydrolysed soils are more easily removed from fabric surfaces in the wash process in the presence of other detergent components. Many known lipases provide good wash performance however, they may also be prone to forming odor-generating short-chain fatty acids during wash and/or have short storage stability.

Stability can be particularly problematic, for example, when in contact with incompatible components of a detergent composition or on exposure to significantly higher or lower temperatures than ambient temperature either during storage or during a wash or treatment step. If stability is not sufficiently robust, this leads to loss of activity or efficacy of the composition as a whole, and in particular to loss of enzyme activity. Wild-type Thermomyces lanuginosus lipase (also known as Humicola lanuginosa) sold under the tradename LIPOLASE™ and variants thereof have been commercialized as active ingredients in detergent compositions for the removal of lipid stains by hydrolyzing triglycerides to generate fatty acids.

WO 2016/102356 discloses lipase variants of Thermomyces lanuginosus lipase with improved stability having E1C+N233C substitutions.

WO 2019/063499 concerns lipase variants of Thermomyces lanuginosus lipase comprising one or more substitutions corresponding to G23S, D27N, A40I, F51I,L, E56R, D57N, V60E,K, K98I, N101D, R118F, G163S, T231R, N233R, Y220F, T244E, and P256T.

There is a need and desire for compositions comprising lipases which provide improved storage stability/longer shelf life/increased thermostability and at the same time provide good cleaning performance and do not have a negative odor profile.

### SUMMARY

In a first aspect, examples detailed herein relate to a liquid laundry detergent composition. The liquid laundry detergent composition comprises:
i) from 5% to 45% by weight of the detergent composition of linear alkylbenzene sulfonate;
ii) a variant of a parent lipase which variant has lipase activity, has at least 60%, but less than 100% sequence identity with SEQ ID NO: 1 or SEQ ID NO: 2 and comprises the following substitutions: I202C+P253C (using SEQ ID NO: 1 for numbering); and
iii) from 2% to 60% by weight of the composition of water.

The detergent compositions as detailed herein present good stability, in particular detergent stability and/or storage stability, compared to the parent lipase, in particular the lipase shown as SEQ ID NO: 1 or SEQ ID NO: 2. The compositions also provide good cleaning and present acceptable odor-generation. This is even the case when the compositions comprise a protease and/or when the composition comprise a reducing agent. Both, proteases and reducing agents, can negatively impact on lipases stability.

There is also provided a water-soluble unit dose article comprising a water-soluble film and the liquid laundry detergent composition as detailed herein. The compositions as detailed herein are well suited to be part of water-soluble pouches.

There is also provided a process of washing fabrics using the detergent composition and/or the water-soluble unit dose article as detailed herein.

In an embodiment, the compositions detailed herein comprise a variant that comprises or consists of mutations corresponding to the set of mutations defined in any one of claims 2, 3, 4, or 5, respectively.

A variant detailed herein has improved stability, in particular detergent stability and/or storage stability, compared to the parent lipase, in particular the lipase shown as SEQ ID NO: 1 or SEQ ID NO: 2.

### SEQUENCES

SEQ ID NO: 1 is a variant of the wild-type Thermomyces lanuginosus lipase shown in SEQ ID NO: 2 and is disclosed in WO 2019/063499 (hereby incorporated by reference).

### SEQ ID NO: 1: (Lipase A)

EVSQDLFNQF NLFAQYSAAA YCSKNNNAPA GTNITCTGNI CPEVEKADAT ILYSFRDSGK
GDVTGFLALD NTNKLIVISF RGSRSIENWI GNLNFDIKEI NDICSGCRGH DGFTSSWFSV
ADTLRQKVED AVREHPDYRV VFTGHSLGGA LATVAGADLR GNGYDIDVFS YGAPRVGNRA
FAEFLTVQTG GTLYRITHIN DIVPRLPPRE FGYSHSSPEY WIKSGTLVPV RRRDIVKIEG
IDAEGGNNQP NIPDITAHLW YFGLIGTCL

SEQ ID NO: 1 has the following substitutions relative to the wild-type lipase shown in SEQ ID NO: 2 obtained from Thermomyces lanuginosus:

$$G 23 S + D 27 N + A 40 I + F 51 I + E 56 R + V 60 K + R 118 F + T 231 R + N 233 R + T 244 E + P 256 T$$

SEQ ID NO: 2 is the wild-type lipase obtained from Thermomyces lanuginosus (TLL).

### SEQ ID NO: 2: (Wild-Type TLL)

EVSQDLFNQF NLFAQYSAAA YCGKNNDAPA GTNITCTGNA CPEVEKADAT FLYSFEDSGV
GDVTGFLALD NTNKLIVLSF RGSRSIENWI GNLNFDLKEI NDICSGCRGH DGFTSSWRSV
ADTLRQKVED AVREHPDYRV VFTGHSLGGA LATVAGADLR GNGYDIDVFS YGAPRVGNRA
FAEFLTVQTG GTLYRITHTN DIVPRLPPRE FGYSHSSPEY WIKSGTLVPV TRNDIVKIEG
IDATGGNNQP NIPDIPAHLW YFGLIGTCL

SEQ ID NO: 3 is a variant of the lipase variant shown in SEQ ID NO: 1.

### SEQ ID NO: 3: (Lipase B)

EVSQDLFNQF NLFAQYSAAA YCGKNNDAPA GTNITCTGNE CPEVEKADAT ILYSFRNSGV
GDVTGFLALD NTNKLIVLSF RGSRSIENWI TNLNFDLEEI NDICSGCKGH DGFTSSWFSV
ADTLRQKVED AVREHPDYRV VFTGHSLGGA LATVAGADLR GNGYDIDVFS YGAPRVGNRA
FAEFLTVQTG GTLYRITNIN DCVPRLPPRQ FGYSHSSPEY WIKSGTLPPV RRRDIVKIEG
IDAEGGNNQP NICSIPAHLW YFGLIGTCL

SEQ ID NO: 3 has the following substitutions relative to the Thermomyces lanuginosus lipase shown in SEQ ID NO: 1:

$$S 23 G + N 27 D + I 40 E + D 57 N + K 60 V + G 91 T + K 98 E + R 108 K + H 198 N + I 202 C + E 210 Q + V 228 P + P 253 C + D 254 S + T 256 P$$

SEQ ID NO: 4 is a subtilisin protease

### SEQ ID NO: 4: (Protease A)

AQSVPWGIER VQAPAAHNRG LTGSGVKVAV LDTGISTHPD LRIRGGASFV PGEPSTQDGN
GHGTHVAGTI AALDNSIGVL GVAPSAELYA VKVLGASGSG SVSSIAQGLE WAGNNGMHVA
NLSLGSPSPS ATLEQAVNSA TSRGVLVVAA SGNSGAGSIS YPARYANAMA VGATDQNNNR
ASFSQYGAGL DIVAPGVNIL STWPGSTYAS LNGTSMATPH VAGAAALVKQ KNPSWSNVQI
RNHLKNTATS LGDTWEYGSG LVNAEAATR

### Definitions

Lipase: The terms “lipase”, “lipase enzyme”, “lipolytic enzyme”, “lipid esterase”, “lipolytic polypeptide”, and “lipolytic protein” refer to an enzyme in class EC3.1.1 as defined by Enzyme Nomenclature. It may have lipase activity (triacylglycerol lipase, EC3.1.1.3), cutinase activity (EC3.1.1.74), sterol esterase activity (EC3.1.1.13) and/or wax-ester hydrolase activity (EC3.1.1.50). For purposes of the present disclosure, lipase activity is determined according to the procedure described in the “Materials & Methods”-section. In one aspect, the variants of the present disclosure have at least 20%, e.g., at least 25%, at least 30%, at least 35%, at least 40%, at least 45%, at least 50%, at least 55%, at least 60%, at least 65%, at least 70%, at least 75%, at least 80%, at least 85%, at least 90%, at least 95%, or 100% of the lipase activity of the polypeptide of SEQ ID NOs: 1, 2 or 3, respectively.

cDNA: The term “cDNA” means a DNA molecule that can be prepared by reverse transcription from a mature, spliced, mRNA molecule obtained from a eukaryotic or prokaryotic cell. cDNA lacks intron sequences that may be present in the corresponding genomic DNA. The initial, primary RNA transcript is a precursor to mRNA that is processed through a series of steps, including splicing, before appearing as mature spliced mRNA.

Coding sequence: The term “coding sequence” means a polynucleotide, which directly specifies the amino acid sequence of a lipase variant. The boundaries of the coding sequence are generally determined by an open reading frame, which begins with a start codon such as ATG, GTG or TTG and ends with a stop codon such as TAA, TAG, or TGA. The coding sequence may be a genomic DNA, cDNA, synthetic DNA, or a combination thereof.

Control sequences: The term “control sequences” means nucleic acid sequences necessary for expression of a polynucleotide encoding a lipase variant of the present disclosure. Each control sequence may be native (i.e., from the same gene) or foreign (i.e., from a different gene) to the polynucleotide encoding the lipase variant or native or foreign to each other. Such control sequences include, but are not limited to, a leader, polyadenylation sequence, propeptide sequence, promoter, signal peptide sequence, and transcription terminator. At a minimum, the control sequences include a promoter, and transcriptional and translational stop signals. The control sequences may be provided with linkers for the purpose of introducing specific restriction sites facilitating ligation of the control sequences with the coding region of the polynucleotide encoding a lipase variant of the present disclosure.

Expression: The term “expression” includes any step involved in the production of a lipase variant including, but not limited to, transcription, post-transcriptional modification, translation, post-translational modification, and secretion.

Expression vector: The term “expression vector” means a linear or circular DNA molecule that comprises a polynucleotide encoding a lipase variant of the present disclosure and is operably linked to control sequences that provide for its expression.

Fragment: The term “fragment” means a polypeptide having one or more (e.g., several) amino acids absent from the amino and/or carboxyl terminus of a polypeptide; wherein the fragment has lipase activity. In one aspect, a fragment contains at least 50%, at least 55%, at least 60%, at least 65%, at least 70%, at least 75%, at least 80%, at least 85%, at least 90%, or at least 95%, at least 96%, at least 97%, at least 98%, at least 99%, but less than 100% of the number of amino acids 1 to 269 of SEQ ID NOs: 1, 2 or 3, respectively.

Half-life: The term “half-life” is the time it takes for an enzyme to lose half of its enzymatic activity under a given set of conditions. It is denoted as T½ or T½ and is measured at a suitable time scale, e.g., hours. In context of the present disclosure half-life is determined as described in the “Materials & Methods” section.

Improvement factor: The term “Improvement Factor” or “IF” is the improvement of half-life of a variant compared to a reference lipase. An improvement factor (IF) under a given set of conditions (detergent concentration and temperature etc) can be calculated as:
IF=(T½ lipase variant)/(T½ lipase reference) where the lipase reference is incubated under the same condition as the lipase variant in question. In the case where a lipase reference (e.g., SEQ ID NO: 1) is not stable at given conditions a more stable variant is used as the lipase reference (e.g., SEQ ID NO: 3).

Host cell: The term “host cell” means any cell type that is susceptible to transformation, transfection, transduction, or the like with a nucleic acid construct or expression vector comprising a polynucleotide of the present disclosure. The term “host cell” encompasses any progeny of a parent cell that is not identical to the parent cell due to mutations that occur during replication.

Improved property: In context of the present disclosure, the term “improved property” means a characteristic associated with a lipase variant that is improved compared to the parent lipase (i.e., SEQ ID NO: 1 or SEQ ID NO: 3). Such improved properties include, but are not limited to stability, including detergent stability, stability in detergent with protease present, stability in detergent with sodium bisulfite present, and/or thermostability, such as storage stability. Another improved property may be reduced odor generation compared to the lipase reference.

Isolated: The term “isolated” means a substance in a form or environment which does not occur in nature. Non-limiting examples of isolated substances include (1) any non-naturally occurring substance, (2) any substance including, but not limited to, any enzyme, variant, nucleic acid, protein, peptide or cofactor, that is at least partially removed from one or more or all of the naturally occurring constituents with which it is associated in nature; (3) any substance modified by the hand of man relative to that substance found in nature; or (4) any substance modified by increasing the amount of the substance relative to other components with which it is naturally associated (e.g., multiple copies of a gene encoding the substance; use of a stronger promoter than the promoter naturally associated with the gene encoding the substance). An isolated substance may be present in a fermentation broth sample.

Mature polypeptide: The term “mature polypeptide” means a polypeptide in its final form following translation and any post-translational modifications, such as N terminal processing, C terminal truncation, glycosylation, phosphorylation, etc. In one aspect, the mature polypeptide is amino acids 1 to 269 of SEQ ID NOs: 1, 2 or 3, respectively. It is known in the art that a host cell may produce a mixture of two or more different mature polypeptides (i.e., with a different C terminal and/or N terminal amino acid(s)) expressed by the same polynucleotide.

Mature polypeptide coding sequence: The term “mature polypeptide coding sequence” means a polynucleotide that encodes a mature polypeptide having lipase activity.

Mutant: The term “mutant” means a polynucleotide encoding a variant.

Nucleic acid construct: The term “nucleic acid construct” means a nucleic acid molecule, either single or double-stranded, which is isolated from a naturally occurring gene or is modified to contain segments of nucleic acids in a manner that would not otherwise exist in nature or which is synthetic, which comprises one or more control sequences.

Operably linked: The term “operably linked” means a configuration in which a control sequence is placed at an appropriate position relative to the coding sequence of a polynucleotide such that the control sequence directs expression of the coding sequence.

Parent or parent lipase: The term “parent” or “parent lipase” means a lipase to which an alteration is made to produce the lipase variants of the present disclosure. The parent lipase may be a naturally occurring (i.e., wild-type) polypeptide, in particular SEQ ID NO: 2, or a variant thereof, in particular SEQ ID NO: 1 or SEQ ID NO: 3, or fragment thereof or may be synthetically produced.

Sequence identity: The relatedness between two amino acid sequences is described by the parameter “sequence identity”.

For purposes of the present disclosure, the sequence identity between two amino acid sequences is determined using the Needleman-Wunsch algorithm (Needleman and Wunsch, 1970, J. Mol. Biol. 48: 443-453) as implemented in the Needle program of the EMBOSS package (EMBOSS: The European Molecular Biology Open Software Suite, Rice et al., 2000, Trends Genet. 16: 276-277), preferably version 5.0.0 or later. The parameters used are gap open penalty of 10, gap extension penalty of 0.5, and the EBLOSUM62 (EMBOSS version of BLOSUM62) substitution matrix. The output of Needle labeled “longest identity” (obtained using the -nobrief option) is used as the percent identity and is calculated as follows:

(Identical Residues×100)/(Length of Alignment−Total Number of Gaps in Alignment)

Stability: The stability of a lipase variant of the present disclosure may be expressed as the residual activity or the residual performance of said lipase during or after exposure to various test conditions such as, e.g., storage in a detergent composition, at various temperatures, at various pH, in the presence of different components such as a protease, chemicals, and/or oxidative substances (stress conditions) or during use in a wash process. The stability of a lipase variant can be measured relative to a known activity or performance of a reference or parent lipase, e.g., the parent lipases shown as SEQ ID NOs: 1, 2, or 3, respectively, or alternatively to a known activity or performance of the lipase variant when initially added to a detergent composition optionally stored cold or frozen or relative to the lipase variant stored cold or frozen (unstressed conditions). In context of the present disclosure, the stability (i.e., detergent stability or storage stability) can be determined, as done in the Examples herein, as an improvement factor (IF) of half-life (T1/2).

Subsequence: The term “subsequence” means a polynucleotide having one or more (e.g., several) nucleotides absent from the 5′ and/or 3′ end of a mature polypeptide coding sequence; wherein the subsequence encodes a fragment having lipase activity.

Variant: The term “variant” means a polypeptide having lipase activity comprising an alteration, i.e., a substitution, insertion, and/or deletion, at one or more (e.g., several) positions. A substitution means replacement of the amino acid occupying a position with a different amino acid; a deletion means removal of the amino acid occupying a position; and an insertion means adding an amino acid adjacent to and immediately following the amino acid occupying a position. The variants of the present disclosure have at least 20%, e.g., at least 40%, at least 50%, at least 60%, at least 70%, at least 80%, at least 90%, at least 95%, or at least 100% of the lipase activity of the polypeptide of SEQ ID NOs: 1, 2 or 3, respectively.

Wild-type lipase: The term “wild-type” lipase means a lipase expressed by a naturally occurring microorganism, such as a bacterium, yeast, or filamentous fungus found in nature.

### Conventions for Designation of Variants

For purposes of the present disclosure, the polypeptide disclosed as SEQ ID NO: 1 is used to determine the corresponding amino acid residue in another lipase. The amino acid sequence of another lipase is aligned with SEQ ID NO: 1, and based on the alignment, the amino acid position number corresponding to any amino acid residue in the polypeptide disclosed in SEQ ID NO: 1 is determined using the Needleman-Wunsch algorithm (Needleman and Wunsch, 1970, J. Mol. Biol. 48: 443-453) as implemented in the Needle program of the EMBOSS package (EMBOSS: The European Molecular Biology Open Software Suite, Rice et al., 2000, Trends Genet. 16: 276-277), preferably version 5.0.0 or later. The parameters used are gap open penalty of 10, gap extension penalty of 0.5, and the EBLOSUM62 (EMBOSS version of BLOSUM62) substitution matrix.

Identification of the corresponding amino acid residue in another lipase can be determined by an alignment of multiple polypeptide sequences using several computer programs including, but not limited to, MUSCLE (multiple sequence comparison by log-expectation; version 3.5 or later; Edgar, 2004, Nucleic Acids Research 32: 1792-1797), MAFFT (version 6.857 or later; Katoh and Kuma, 2002, Nucleic Acids Research 30: 3059-3066; Katoh et al., 2005, Nucleic Acids Research 33: 511-518; Katoh and Toh, 2007, Bioinformatics 23: 372-374; Katoh et al., 2009, Methods in Molecular Biology 537: 39-64; Katoh and Toh, 2010, Bioinformatics 26: 1899-1900), and EMBOSS EMMA employing ClustalW (1.83 or later; Thompson et al., 1994, Nucleic Acids Research 22: 4673-4680), using their respective default parameters.

When the other enzyme has diverged from the polypeptide of SEQ ID NO: 1 such that traditional sequence-based comparison fails to detect their relationship (Lindahl and Elofsson, 2000, J. Mol. Biol. 295: 613-615), other pairwise sequence comparison algorithms can be used. Greater sensitivity in sequence-based searching can be attained using search programs that utilize probabilistic representations of polypeptide families (profiles) to search databases. For example, the PSI BLAST program generates profiles through an iterative database search process and is capable of detecting remote homologs (Atschul et al., 1997, Nucleic Acids Res. 25: 3389-3402). Even greater sensitivity can be achieved if the family or superfamily for the polypeptide has one or more representatives in the protein structure databases. Programs such as GenTHREADER (Jones, 1999, J. Mol. Biol. 287: 797-815; McGuffin and Jones, 2003, Bioinformatics 19: 874-881) utilize information from a variety of sources (PSI BLAST, secondary structure prediction, structural alignment profiles, and solvation potentials) as input to a neural network that predicts the structural fold for a query sequence. Similarly, the method of Gough et al., 2000, J. Mol. Biol. 313: 903-919, can be used to align a sequence of unknown structure with the superfamily models present in the SCOP database. These alignments can in turn be used to generate homology models for the polypeptide, and such models can be assessed for accuracy using a variety of tools developed for that purpose.

For proteins of known structure, several tools and resources are available for retrieving and generating structural alignments. For example, the SCOP superfamilies of proteins have been structurally aligned, and those alignments are accessible and downloadable. Two or more protein structures can be aligned using a variety of algorithms such as the distance alignment matrix (Holm and Sander, 1998, Proteins 33: 88-96) or combinatorial extension (Shindyalov and Bourne, 1998, Protein Engineering 11: 739-747), and implementation of these algorithms can additionally be utilized to query structure databases with a structure of interest in order to discover possible structural homologs (e.g., Holm and Park, 2000, Bioinformatics 16: 566-567).

In describing the variants of the present disclosure, the nomenclature described below is adapted for ease of reference. The accepted IUPAC single letter or three letter amino acid abbreviation is employed.

Substitutions. For an amino acid substitution, the following nomenclature is used: Original amino acid, position, substituted amino acid. Accordingly, the substitution of threonine at position 226 with alanine is designated as “Thr226Ala” or “T226A”.

Deletions. For an amino acid deletion, the following nomenclature is used: Original amino acid, position, *. Accordingly, the deletion of glycine at position 195 is designated as “Gly195*” or “G195*”. Multiple deletions are separated by addition marks (“+”), e.g., “Gly195*+Ser411*” or “G195*+S411*”.

Insertions. For an amino acid insertion, the following nomenclature is used: Original amino acid, position, original amino acid, inserted amino acid. Accordingly the insertion of lysine after glycine at position 195 is designated “Gly195GlyLys” or “G195GK”. An insertion of multiple amino acids is designated [Original amino acid, position, original amino acid, inserted amino acid #1, inserted amino acid #2; etc.]. For example, the insertion of lysine and alanine after glycine at position 195 is indicated as “Gly195GlyLysAla” or “G195GKA”.

In such cases the inserted amino acid residue(s) are numbered by the addition of lower-case letters to the position number of the amino acid residue preceding the inserted amino acid residue(s). In the above example, the sequence would thus be:

### Parent: Variant:

195 195 195a 195b
G G - K - A

Multiple alterations. Multiple mutations are separated by addition marks (“+”), e.g., “Gly205Arg+Ser411Phe” or “G205R+S411F”, representing substitutions at positions 205 and 411 of glycine (G) with arginine (R) and serine (S) with phenylalanine (F), respectively. Multiple mutations may also be separated by a space (“ ”), e.g., G205R S411F”, or a comma “,”, e.g., “G205R, S411F”, representing substitutions at positions 205 and 411 of glycine (G) with arginine (R) and serine (S) with phenylalanine (F), respectively.

Different alterations. Where different alterations can be introduced at a position, the different alterations are separated by a comma, e.g., “Arg170Tyr,Glu” represents a substitution of arginine at position 170 with tyrosine or glutamic acid. Thus, “Tyr167Gly,Ala+Arg170Gly,Ala” designates the following variants:

$$“ Tyr 167 Gly + Arg 170 Gly ” , “ Tyr 167 Gly + Arg 170 Ala ” , “ Tyr 167 Ala + Arg 170 Gly ” , and “ Tyr 167 Ala + Arg 170 Ala ” .$$

### DETAILED DESCRIPTION

It is usually challenging to improve lipases stability without negatively impacting performance and/or odor generation. The present disclosure relates to detergent compositions comprising lipase variants that are improved compared to a parent or reference lipase. More specifically, the present disclosure relates to lipase variants providing a good balance of good cleaning, reduced malodor and improved stability. The variants have improved stability, in particular improved detergent stability and/or storage stability, e.g., determined as relative detergent stability improvement factor compared to a parent or reference lipase, in particular the lipases shown in SEQ ID NO: 1 and SEQ ID NO: 2, respectively.

The improvement in stability, in particular detergent stability and/or storage stability, is according to the present disclosure calculated as an Improvement Factor (IF) as described herein. The Improvement Factor (IF) of the parent or reference lipase, e.g., the lipase shown in SEQ ID NO: 1, is 1.0. A lipase variant of the present disclosure with improved stability has an IF above 1.0 (>1.0).

Unless otherwise indicated the amounts in percentage is by weight of the composition (wt %).

### Lipase Variant of the Present Disclosure

The lipase in the compositions of the present disclosure is sometimes herein referred to as “the lipase of the present disclosure”.

The lipase of the present disclosure is a variant of a parent lipase which variant has lipase activity, has at least 60%, but less than 100% sequence identity with SEQ ID NO: 1 or SEQ ID NO: 2 and comprises a cysteine bridge in positions 202 and 253 (using SEQ ID NO: 1 for numbering). The variant has the following substitutions: I202C+P253C. Preferably, the variant has at least 70%, preferably at least 80%, preferably at least 85%, preferably at least 90%, preferably at least 95%, preferably at least 98% sequence identity with SEQ ID NO: 1. Preferably, the variant has at least 70%, preferably at least 80%, preferably at least 85%, preferably at least 90%, preferably at least 95%, preferably at least 98% sequence identity with SEQ ID NO: 2.

Preferably, the variant comprises one or more of the following substitutions S23G, N27D, I40E, D57N, K60V, G91T, K98E, R108K, H198N, I202C, E210Q, V228P, P253C. D254S and T256P, Preferably, the variant comprises one or more of the following substitutions I40E, D57N, G91T, K98E, R108K, H198N, I202C, E210Q, V228P, P253C. D254S, T256P and L264P. Preferably the variant comprises at least two, preferably at least three, preferably at least four, preferably at least five, preferably at least six, preferably at least seven or more of the following substitutions S23G, N27D, I40E, D57N, K60V, G91T, K98E, R108K, H198N, I202C, E210Q, V228P, P253C. D254S, T256P, L264P. Preferably, the variant comprises all the substitutions: S23G, N27D, I40E, D57N, K60V, G91T, K98E, R108K, H198N, I202C, E210Q, V228P, P253C. D254S, T256P and L264P.

A specially preferred variant comprises H198N substitution.

Especially preferred variants herein comprise or consists of substitutions corresponding to the following set of substitutions:

$$S 23 G + N 27 D + I 40 E + D 57 N + K 60 V + G 91 T + K 98 E + R 108 K + H 198 N + I 202 C + E 210 Q + V 228 P + P 253 C + D 254 S + T 256 P$$

$$S 23 G + N 27 D + I 40 E + D 57 N + K 60 V + G 91 N + K 98 E + R 108 K + Y 138 A + T 143 A + G 149 A + G 156 Y + A 173 S + H 198 N + I 202 C + E 210 F + V 228 P + P 253 C + D 254 S + T 256 P + L 264 P$$

$$N 11 Q + S 23 G + N 27 D + I 40 E + D 57 N + K 60 V + G 91 T + K 98 E + S 105 E + R 108 K + G 109 A + V 154 L + S 170 T + A 173 Q + H 198 N + I 202 C + E 210 Q + V 228 P + P 253 C + D 254 S + T 256 P + L 264 P$$

$$S 23 G + N27 D + A 30 N + I 40 E + D 57 N + K 60 V + L 75 D + G 91 T + K 98 E + R 108 K + G 109 A + H 198 N + T 199 Q + I 202 C + E 210 Q + V 228 P + P 253 C + D 254 S + T 256 P + L 264 P$$

$$Q 9 H + S23 G + N 27 D + I 40 E + D 57 N + K 60 V + G 91 T + K 98 E + R 108 K + G 109 A + Y 138 L + H 198 N + I 202 C + E 210 Q + V 228 P + P 253 C + D 254 S + T 256 P + L 264 P$$

$$Q 9 H + S23 G + N 27 D + I 40 E + D 57 N + K 60 V + G 91 T + K 98 E + R 108 K + G 109 A + V 154 L + H 198 N + I 202 C + E 210 Q + V 228 P + P 253 C + D 254 S + T 256 P + L 264 P$$

These variants present improved stability versus the parent in a laundry detergent composition, even if the detergent composition comprises a protease and/or a reducing agent.

### Liquid Laundry Detergent Composition

The term ‘liquid laundry detergent composition’ refers to any laundry detergent composition comprising a liquid capable of wetting and treating a fabric, and includes, but is not limited to, liquids, gels, pastes, dispersions and the like. The liquid composition can include solids or gases in suitably subdivided form, but the liquid composition excludes forms which are non-fluid overall, such as tablets or granules. The laundry detergent composition can be used in a fabric hand wash operation or may be used in an automatic machine fabric wash operation.

The laundry detergent composition preferably comprises a non-soap surfactant system. The non-soap surfactant system comprises anionic non-soap surfactant and non-ionic surfactant. The anionic non-soap surfactant is selected from the group consisting of: linear alkyl benzene sulphonate, alkyl ether sulphate, alkyl sulphate and mixtures thereof. The nonionic surfactant is selected from the group consisting of: primary alcohol ethoxylate, secondary alcohol ethoxylate, and mixtures thereof. The liquid laundry detergent composition comprises from 5% to 45%, preferably from 10% to 35% by weight of the liquid laundry detergent composition of linear alkylbenzene sulfonate.

The liquid laundry detergent composition preferably comprises a protease. The liquid laundry detergent composition preferably comprises an additional enzyme selected from the group consisting of alginate lyase, aminopeptidase, amylase, carbohydrase, carboxypeptidase, catalase, cellulase, chitinase, cutinase, glycosyltransferase, esterase, alpha-galactosidase, beta-galactosidase, glucoamylase, alpha-glucosidase, beta-glucosidase, haloperoxidase, hexosaminidase, invertase, laccase, lipase, mannanase, mannosidase, nuclease, oxidase, pectinolytic enzyme, peptidoglutaminase, peroxidase, phytase, polyphenoloxidase, proteolytic enzyme, transglutaminase, xylanase, xanthan lyase, xanthanase, endo-p 1,3-glucanase and mixtures thereof.

Preferably, the liquid laundry detergent composition comprises a protease and an additional enzyme selected from the group consisting of amylase, cellulase, lipases, xyloglucanases, mannanases, nucleases, pectate lyases, and a mixture thereof. Preferably, the liquid laundry detergent composition comprises a protease, an amylase and an additional enzyme selected from the group consisting of cellulase, lipases, xyloglucanases, mannanases, nucleases, pectate lyases, and a mixture thereof. The liquid laundry detergent composition preferably comprises a reducing agent, preferably from 0.01% to 1% by weight of the liquid laundry detergent composition of a reducing agent, more preferably 0.01% to 1% by weight of the liquid laundry detergent composition of sodium bisulphite.

The liquid laundry detergent composition preferably comprises a cleaning adjunct selected from the group consisting of: anti-redeposition agents, neutralizers, optical brighteners, foam inhibitors, chelators, bittering agents, dye transfer inhibitors, soil release agents, water softeners, electrolytes, pH regulators, anti-graying agents, anti-crease components, colorants, scents, processing aids, and mixtures thereof.

### Water-Soluble Unit Dose Article

The present disclosure relates to a water-soluble unit dose article comprising a water-soluble film and a detergent composition, preferably a liquid laundry detergent composition. The water-soluble film and the laundry detergent composition are described in more detail below.

The water-soluble unit dose detergent article comprises the water-soluble film shaped such that the unit-dose article comprises at least one internal compartment surrounded by the water-soluble film. The unit dose article may comprise a first water-soluble film and a second water-soluble film sealed to one another such to define the internal compartment. The water-soluble unit dose article is constructed such that the detergent composition does not leak out of the compartment during storage. However, upon addition of the water-soluble unit dose article to water, the water-soluble film dissolves and releases the contents of the internal compartment into the wash liquor.

The compartment should be understood as meaning a closed internal space within the unit dose article, which holds the detergent composition. During manufacture, a first water-soluble film may be shaped to comprise an open compartment into which the detergent composition is added. A second water-soluble film is then laid over the first film in such an orientation as to close the opening of the compartment. The first and second films are then sealed together along a seal region.

The unit dose article may comprise more than one compartment, even at least two compartments, or even at least three compartments, or even at least four compartments. The compartments may be arranged in superposed orientation, i.e. one positioned on top of the other. In such an orientation the unit dose article will comprise at least three films, top, one or more middle, and bottom. Alternatively, the compartments may be positioned in a side-by-side orientation, i.e. one orientated next to the other. The compartments may even be orientated in a ‘tyre and rim’ arrangement, i.e. a first compartment is positioned next to a second compartment, but the first compartment at least partially surrounds the second compartment but does not completely enclose the second compartment. Alternatively, one compartment may be completely enclosed within another compartment.

Wherein the unit dose article comprises at least two compartments, one of the compartments may be smaller than the other compartment. Wherein the unit dose article comprises at least three compartments, two of the compartments may be smaller than the third compartment, and preferably the smaller compartments are superposed on the larger compartment. The superposed compartments preferably are orientated side-by-side. The unit dose article may comprise at least four compartments, three of the compartments may be smaller than the fourth compartment, and preferably the smaller compartments are superposed on the larger compartment. The superposed compartments preferably are orientated side-by-side.

In a multi-compartment orientation, the detergent composition according to the present disclosure may be comprised in at least one of the compartments. It may for example be comprised in just one compartment, or may be comprised in two compartments, or even in three compartments, or even in four compartments.

Each compartment may comprise the same or different compositions. The different compositions could all be in the same form, or they may be in different forms.

The water-soluble unit dose article may comprise at least two internal compartments, wherein the laundry detergent composition is comprised in at least one of the compartments, preferably wherein the unit dose article comprises at least three compartments, wherein the detergent composition is comprised in at least one of the compartments.

The water-soluble unit dose article may comprise from 1 gram up to 60 gram, preferably from 5 gram up to 50 gram, more preferably from 10 gram up to 40 gram, most preferably from 12 gram up to 25 gram alternatively from 30 gram to 40 gram of the laundry detergent composition. The water-soluble unit dose article may comprise from 1 ml up to 60 ml, preferably from 5 ml up to 50 ml, more preferably from 10 ml up to 40 ml, most preferably from 12 ml up to 25 ml, alternatively from 30 ml to 40 ml of the liquid laundry detergent composition.

The laundry detergent composition may comprise from 40% to 65%, preferably from 45% to 60%, more preferably from 45% to 55% by weight of the composition of a non-soap surfactant system. The non-soap surfactant system comprises a non-soap anionic surfactant and a nonionic surfactant system, wherein the nonionic surfactant comprises, preferably consists of, alcohol ethoxylate surfactant. The weight ratio of non-soap anionic surfactant to non-ionic surfactant preferably is less than or equal to 1.5:1 preferably from 1.5:1 to 1:2, more preferably from 1.5:1 to 1:1. The non-soap anionic surfactant comprises linear alkylbenzene sulfonate, preferably selected from neutralised linear alkylbenzene sulphonate an optionally neutralised alkyl sulphate anionic surfactant selected from neutralised alkoxylated alkyl sulphate, neutralised non-alkoxylated alkyl sulphate, and mixtures thereof. The non-soap anionic surfactant may comprise a mixture of neutralised linear alkylbenzene sulphonate and neutralised alkyl sulphate anionic surfactant. The weight ratio of neutralised linear alkylbenzene sulphonate to neutralised alkyl sulphate anionic surfactant may be from 1:2 to 9:1, or from 1:1 to 7:1, or from 1.5:1 to 6:1, or from 1.5:1 to 5:1. Alternatively the non-soap anionic surfactant system may be free of neutralised alkyl sulphate anionic surfactant. Alternatively, the non-soap anionic surfactant system may consist of neutralized linear alkylbenzene sulphonate. For surfactant weight % or weight ratio calculation the weight of the neutralizing counterion in the case of anionic surfactants is not taken into account, e.g. for soap or non-soap anionic surfactants solely the weight of the surfactant anion is considered when calculating the soap or non-soap anionic surfactant weight % or soap or non-soap anionic surfactant to nonionic surfactant weight ratio.

The non-soap anionic surfactant comprises linear alkylbenzene sulphonate. Preferably, the linear alkylbenzene sulphonate comprises C10-C16 alkyl benzene sulfonate, C11-C14 alkyl benzene sulphonate or a mixture thereof. Preferably, the alkylbenzene sulphonate is an amine neutralized alkylbenzene sulphonate, an alkali metal neutralized alkylbenzene sulphonate or a mixture thereof. The amine is preferably selected from monoethanolamine, triethanolamine, monoisopropanolamine or mixtures thereof. The alkali metal is preferably selected from sodium, potassium, magnesium or a mixture thereof. Preferably, the liquid laundry detergent composition comprises between 5% and 45%, preferably between 7.5% and 40%, more preferably between 10% and 35% by weight of the laundry detergent composition of the linear alkylbenzene sulphonate.

The non-soap anionic surfactant may comprise an alkyl sulphate anionic surfactant wherein the alkyl sulphate anionic surfactant is selected from alkyl sulphate, an alkoxylated alkyl sulphate, or a mixture thereof. The alkyl sulphate anionic surfactant may be a primary or a secondary alkyl sulphate anionic surfactant, or a mixture thereof, preferably a primary alkyl sulphate anionic surfactant. Preferably, the alkoxylated alkyl sulphate comprises ethoxylated alkyl sulphate, propoxylated alkyl sulphate, a mixed ethoxylated/propoxylated alkyl sulphate, or a mixture thereof, more preferably an ethoxylated alkyl sulphate. Preferably, the ethoxylated alkyl sulphate has an average degree of ethoxylation of between 0.1 to 5, preferably between 0.5 and 3. Alternatively the alkyl sulphate anionic surfactant is free of alkoxylation. Preferably, the alkyl sulphate anionic surfactant has an average alkyl chain length of between 8 and 18, more preferably between 10 and 16, most preferably between 12 and 15. Preferably, the alkyl chain of the alkyl sulphate anionic surfactant is linear, branched or a mixture thereof. Preferably, the branched alkyl sulphate anionic surfactant is a branched primary alkyl sulphate, a branched secondary alkyl sulphate, or a mixture thereof, preferably a branched primary alkyl sulphate, wherein the branching preferably is in the 2-position, or alternatively might be present further down the alkyl chain, or could be multi-branched with branches spread over the alkyl chain. The weight average degree of branching of alkyl sulphate anionic surfactant may be from 0% to 100% preferably from 0% to 95%, more preferably from 0% to 60%, most preferably from 0% to 20%. Alternatively, the weight average degree of branching of alkyl sulphate anionic surfactant may be from 70% to 100%, preferably from 80% to 90%. Preferably, the alkyl chain is selected from naturally derived material, synthetically derived material or mixtures thereof. Preferably, the synthetically derived material comprises oxo-synthesized material, Ziegler-synthesized material, Guerbet-synthesized material, aldol condensation-synthesized material, Fischer-Tropsch—synthesized material, iso-alkyl synthesized material, or mixtures thereof, preferably oxo-synthesized material. Preferably, the laundry detergent composition comprises between 1% and 20%, preferably between 2% and 15%, more preferably between 4% and 10% by weight of the laundry detergent composition of the alkyl sulphate anionic surfactant. Alternatively, the composition is free of alkyl sulphate anionic surfactant. When alkyl ethoxy sulphate is present in the laundry detergent composition, the alkyl ethoxy sulphate starting material may have been treated to reduce the 1,4-dioxane content down to a level as low as less than 1 ppm per surfactant active. The skilled person will be aware of technical means to reduce the dioxane content in surfactant starting materials, including (multi-step) steam stripping, nano-filtration, or a combination thereof.

The liquid laundry detergent composition preferably comprises a non-ionic surfactant. The non-ionic surfactant comprises, preferably consists of, an ethoxylated alcohol non-ionic surfactant. Preferably, the laundry detergent composition comprises between 5% and 45%, or between 10% and 40%, or between 15% and 35% by weight of the laundry detergent composition of the ethoxylated alcohol non-ionic surfactant. The ethoxylated alcohol non-ionic surfactant may be a primary nonionic surfactant, a secondary nonionic surfactant, or a mixture thereof. Preferably the nonionic surfactant comprises a mixture of primary and secondary ethoxylated alcohol nonionic surfactant, more preferably wherein the primary and the secondary ethoxylated alcohol nonionic surfactant are present in a weight ratio of from 2:1 to 1:10, preferably from 1.5:1 to 1:7, more preferably from 1:1 to 1:5. The ethoxylated alcohol nonionic surfactant may be linear or may be branched. When branched, the branching may be at the 1-position, the 2-position or even further down the alkyl chain, wherein the carbon counting starts as of the carbon linked to the oxygen linker between the alkyl chain and the ethoxylation chain, The branching may be a single branching or a multi-branching. Most preferably the branching is a single branching at the 2-position. The branching preferably is an alkyl branching, more preferably a methyl, ethyl, propyl, butyl or pentyl branching, most preferably mixtures thereof. When linear the alkyl chain of the alcohol may have a natural distribution of C6 to C20 alkyl chains pending the source of the material. Alternatively, the linear alkyl alcohol may have been fractionated to magnify the C12 to C14 alkyl chain content. The ethoxylated alcohol non-ionic surfactant comprises an alkyl chain having an average of from 8 to 18 carbon atoms, preferably of from 10 to 16 more preferably 12 to 15 carbon atoms. The ethoxylated alcohol nonionic surfactant has an average degree of ethoxylation between 5 and 12, preferably between 6 and 10. The ethoxylated alcohol nonionic surfactant may have a broad range (BRE) or a narrow range (NRE) ethoxylation distribution. Narrow-range ethoxylates (NREs) are alcohol polyglycol ethers with a narrow homolog distribution and are known nonionic surfactants. Peaked alkoxylation and peaked ethoxylation are also often used to describe the process and materials produced. They can be produced industrially, for example, by the addition of ethylene oxide onto alcohols in the presence of suitable catalysts (layer compounds which have been calcined or hydrophobized with fatty acids). Examples of narrow range alkoxylation catalysts include many alkaline earth (Mg, Ca, Ba, Sr, etc.) derived catalysts, Lewis acid catalysts, such as Zirconium dodecanoxide sulfate, and certain boron halide catalysts, such as those described by Dupont and of the form MB(OR1)×(X)4-x or B(OR1)3/MX wherein R1 is a linear, branched, cyclic, or aromatic hydrocarbyl group, optionally substituted, having from 1 to 30 carbon atoms, M is Na+, K+, Li+, R2R3R4R5N+, or R2R3R4R5P+, where R2, R3, R4, and R5 independently are hydrocarbyl groups, and x is 1 to 3. This process can also be carried out on a variety of other hydrophobes and using different alkoxylating compounds (e.g., propylene oxide and butylene oxide) by modifying the catalyst properties. The narrow range ethoxylated alcohol non-ionic surfactant comprises at least 85% by weight of the total narrow range ethoxylate alcohol surfactant of alcohol ethoxylate nonionic surfactant molecules comprising a polyethoxy group comprising between 5 and 12, preferably between 6 and 10 ethoxy groups. The broad range ethoxylated alcohol non-ionic surfactant comprises polyethoxy groups, preferably, wherein between 15% and 45%, preferably between 25% and 40% by weight of the total broad range ethoxylated alcohol surfactant are ethoxylated alcohol nonionic surfactant molecules comprising a polyethoxy group comprising between 6 and 10 ethoxy groups, and wherein between 30% and 70%, preferably between 40% and 65% by weight of the total broad range ethoxylated alcohol surfactant are ethoxylated alcohol nonionic surfactant molecules comprise a polyethoxy group comprising between 5 and 12 ethoxy groups. The ethoxylated alcohol non-ionic surfactants may be derived from a natural alcohol source, a synthetic alcohol source, or a mixture thereof. Most suitable natural sources include palm kernel oil, coconut oil, or mixtures thereof, preferably palm kernel oil. When the ethoxylated alkyl alcohol non-ionic surfactant is derived from a synthetic alcohol source, the synthetic alcohol source preferably is made via an oxo process, a Ziegler process, a Guerbet process, an aldol condensation process, or a mixture thereof. The resulting alcohols can optionally but preferably be further fractionated to magnify the C12 to C15 content within the starting alcohol. Suitable examples of narrow range ethoxylated alcohol non-ionic surfactants are commercially available from the Nouryon company under the Berol or Ethylan tradenames, and from the Sasol company under the Novel tradename.

The liquid laundry detergent composition may comprise a fatty acid, preferably a neutralized fatty acid soap. The fatty acid soap may be an amine neutralized fatty acid soap, wherein the amine is an alkanolamine more preferably selected from monoethanolamine, diethanolamine, triethanolamine, monoisopropanolamine or a mixture thereof, more preferably monoethanolamine. The liquid laundry detergent composition may comprise between 1% and 20%, preferably between 3% and 17%, more preferably between 5% and 15% by weight of the laundry detergent composition of fatty acid, preferably a neutralized fatty acid soap.

The laundry detergent comprises between 2% and 80%, preferably between 2% and 60%, preferably between 5% and 25%, more preferably between 10% and 15% by weight of the liquid laundry detergent composition of water.

The liquid laundry detergent composition may comprise one or more proteases. A mixture of two or more proteases can contribute to an enhanced cleaning across a broader temperature, cycle duration, and/or substrate range, and provide superior cleaning benefits. The liquid laundry detergent composition may comprise a serine protease and/or a metalloprotease.

Suitable serine proteases for use herein include neutral or alkaline microbial serine proteases, such as subtilisins (EC 3.4.21.62). Suitable proteases include those of animal, vegetable or microbial origin. In one aspect, such suitable protease may be of microbial origin. The suitable proteases include chemically or genetically modified mutants of the aforementioned suitable proteases. In one aspect, the suitable protease may be an alkaline microbial protease or/and a trypsin-type protease. Examples of suitable neutral or alkaline proteases include:
i) subtilisins (EC 3.4.21.62), especially those derived from Bacillus, such as Bacillus sp., B. lentus, B. alkalophilus, B. subtilis, B. amyloliquefaciens, B. gibsonii, B. akibaii, Bacillus Clausii and B. clarkii described in WO2004067737, WO2015091989, WO2015091990, WO2015024739, WO2015143360, U.S. Pat. No. 6,312,936 B1, U.S. Pat. Nos. 5,679,630, 4,760,025, WO03/055974, WO03/054185, WO03/054184, WO2017/215925, DE102006022216A1, WO2015089447, WO2015089441, WO2016066756, WO2016066757, WO2016069557, WO2016069563, WO2016069569, WO2016174234, WO2017/089093, WO2020/156419, WO2016/183509. Specifically, mutations S9R, A15T, V66A, A188P, V199L, N212D, Q239R, N255D, X9E, X200L, X256E, X9R, X19L, X60D (Savinase numbering system)
ii) subtilisins from B. Pumilus such as the ones described in DE102006022224A1, WO2020/221578, WO2020/221579, WO2020/221580, including variants comprising amino acid substitutions in at least one or more of the positions selected from 9, 130, 133, 144, 224, 252, 271 (BPN′ numbering system).
iii) trypsin-type or chymotrypsin-type proteases, such as trypsin (e.g., of porcine or bovine origin), including the Fusarium protease described in WO 89/06270 and the chymotrypsin iv) proteases derived from Cellumonas described in WO 05/052161 and WO 05/052146; and
v) protease having at least 90% identity to the subtilase from Bacillus sp. TY145, NCIMB 40339, described in WO92/17577 (Novozymes A/S), including the variants of this Bacillus sp TY145 subtilase described in WO2015024739, and WO2016066757.

Preferred proteases for the liquid laundry detergent composition of the present disclosure are polypeptides demonstrating at least 90%, preferably at least 95%, more preferably at least 98%, even more preferably at least 99% and especially 100% identity with the wild-type enzyme from Bacillus lentus, comprising mutations in one or more, preferably two or more and more preferably three or more of the following positions, using the BPN′ numbering system and amino acid abbreviations as illustrated in WO00/37627, which is incorporated herein by reference: S9R, A15T, V68A, N76D, N87S, S99D, S99SD, S99A, S101G, S101M, S103A, V104N/I, G118V, G118R, S128L, P129Q, S130A, Y167A, R170S, A194P, V205L, Q206L/D/E, Y209W, M222S, Q245R and/or M222S.

Especially preferred additional protease is selected from the group of proteases comprising the below mutations (BPN′ numbering system) versus either the PB92 wild-type (SEQ ID NO:2 in WO 08/010925) or the subtilisin 309 wild-type (sequence as per PB92 backbone, except comprising a natural variation of N87S).

$$( i ) G 118 V + S 128 L + P 129 Q + S 130 A$$

$$( ii ) S 101 M + G 118 V + S 128 L + P 129 Q + S 1 \; 30 A$$

$$( iii ) N 76 D + N 87 R + G 118 R + S 128 L + P 129 Q + S 130 A + S 188 D + N 248 R$$

$$( iv ) N 76 D + N 87 R + G 118 R + S 128 L + P 129 Q + S 130 A + S 188 D + V 244 R$$

$$( v ) N 76 D + N 87 R + G 118 R + S 128 L + P 129 Q + S 1 \; 30 A$$

$$( vi ) V 68 A + N 87 S + S 101 G + V 1 \; 04 N$$

$$( vii ) S 99 AD$$

$$( viii ) S 9 R + A 15 T + V 68 A + N 218 D + Q 245 R$$

The most preferred protease is a subtilase variant derived from B. amyloliquefaciens (BPN′), as described in WO2011/072117. Especially useful BPN′ variant comprises mutation in one or more of the following positions: X003Q, X006W, X022Y, X024K, X024Q, X024G, X033T, X045V, X053G, X055P, S063T, X076D, X078N, X087D, X101N, X109Q, X118R, X128A, X128S, X145R, X166Q, X169A, X162Q, X182Q, X183N, S183T, X204Q, X206Y, X217Q, Y217L, X218S, X222Q, X248A or X254A; (in BPN′numbering system).

Suitable commercially available protease enzymes include;
i) those sold under the trade names Alcalase®, Savinase®, Primase®, Durazym®, Polarzyme®, Kannase®, Liquanase®, Liquanase Ultra®, Savinase Ultra®, Liquanase® Evity®, Savinase® Evity®, Ovozyme®, Neutrase®, Everlase®, Coronase®, Blaze®, Blaze Ultra®, Blaze® Evity®, Blaze® Exceed, Blaze® Pro, Esperase®, Progress® Uno, Progress® Excel, Progress® Key, Ronozyme®, Vinzon® and Het Ultra® by Novozymes A/S (Denmark); ii) those sold under the tradename Maxatase®, Maxacal®, Maxapem®, Properase®, Purafect®, Purafect Prime®, Purafect Ox®, FN3®, FN4®, Excellase®, Ultimase® and Purafect OXP®, Preferenz® by IFF (formerly Dupont); and
iii) those sold under the tradename Opticlean® and Optimase® by Solvay Enzymes; iv) those available from Henkel/Kemira, namely BLAP (sequence shown in FIG. 29 of U.S. Pat. No. 5,352,604 with the following mutations S99D+S101R+S103A+V104I+G159S, hereinafter referred to as BLAP), BLAP R (BLAP with S3T+V4I+V199M+V205I+L217D), BLAP X (BLAP with S3T+V4I+V205I) and BLAP F49 (BLAP with S3T+V4I+A194P+V199M+V205I+L217D); and can comprise a further mutation 101E/D, S156D, L262E, 206A/US/T/, 209K/V/W, 215W, 216N/S/T; and
v) those sold under the tradename Lavergy®, Lavergy® Pro, Lavergy® C Bright from BASF.

Especially preferred for use herein are commercial proteases selected from the group consisting of Properase®, Blaze®, Ultimase®, Everlase®, Savinase®, Excellase®, Blaze Ultra®, BLAP and BLAP variants (Lavergy® Pro).

Preferred levels of protease in the product of the present disclosure include from about 0.05 to about 10, more preferably from about 0.5 to about 7 and especially from about 1 to about 6 mg of active protease/g of composition.

Preferably, the liquid laundry detergent composition comprises between 5% and 20%, preferably between 10% and 17% by weight of the liquid laundry detergent composition of a non-aqueous organic solvent, preferably wherein the non-aqueous organic solvent is selected from 1,2-propanediol, dipropylene glycol, tripropyleneglycol, glycerol, sorbitol, polyethylene glycol, ethoxylated glycerin or a mixture thereof. Preferably the non-aqueous organic solvent comprises 1,2-propanediol and glycerol, more preferably wherein the 1,2-propanediol and glycerol are in a weight ratio of from 1:3 to 12:1, preferably of from 1:2 to 9:1, more preferably from 1:1 to 6:1. The liquid laundry composition preferably comprises less than 1% preferably less than 0.5% by weight of the composition of ethanol, most preferably the laundry composition is free of ethanol.

Preferably, the laundry detergent composition comprises an adjunct ingredient selected from the group comprising builders, perfumes, enzymes, citrate, bleach, bleach catalyst, dye, hueing dye, brightener, cleaning polymers including alkoxylated polyamines and polyethyleneimines, soil release polymer, fabric care polymers including cationic hydroxyethyl celluloses, cationic guar gums and cationic polyglucans, surfactant, solvent, dye transfer inhibitors, chelant, encapsulated perfume, polycarboxylates, structurant, pH trimming agents, anti-oxidants including Ralox 35, anti-foam agent, and mixtures thereof.

Compositions comprising perfume can lead to yellowing of the composition. This problem can be ameliorated by adding reducing agents to the composition. Preferably the composition comprises from 0.01% to 1%, preferably from 0.05% to 0.8%, more preferably from 0.1% to 0.5% by weight of the liquid laundry detergent composition of a reducing agent. Preferably, the reducing agent is selected from the group consisting of sodium sulphite, calcium sulphite, potassium sulphite, magnesium sulphite, bisulphite, sodium bisulphite, calcium bisulphite, potassium bisulphite, magnesium bisulphite, and a mixture thereof. Most preferably the reducing agent is sodium bisulphite.

Preferably, the laundry detergent composition comprises a further enzyme selected from the group comprising hemicellulases, peroxidases, proteases, cellulases, xylanases, lipases, phospholipases, esterases, cutinases, pectinases, keratanases, reductases, oxidases, phenoloxidases, lipoxygenases, ligninases, pullulanases, tannases, pentosanases, malanases, ß-glucanases, arabinosidases, hyaluronidase, chondroitinase, laccase, xyloglucanases, mannanases and amylases, nuclease, pectate lyases, or mixtures thereof, preferably a further enzyme selected from the group comprising proteases, amylase, cellulase, lipases, xyloglucanases, mannanases, nucleases, pectate lyases, and mixtures thereof

Preferably, the laundry detergent composition has a pH between 6 and 10, more preferably between 6.5 and 8.9, most preferably between 7 and 8, wherein the pH of the laundry detergent composition is measured as a 10% product concentration in demineralized water at 20° C.

When liquid, the liquid laundry detergent composition may be Newtonian or non-Newtonian. Preferably, the liquid laundry detergent composition is non-Newtonian. Without wishing to be bound by theory, a non-Newtonian liquid has properties that differ from those of a Newtonian liquid, more specifically, the viscosity of non-Newtonian liquids is dependent on shear rate, while a Newtonian liquid has a constant viscosity independent of the applied shear rate. The decreased viscosity upon shear application for non-Newtonian liquids is thought to further facilitate liquid detergent dissolution. The liquid laundry detergent composition described herein can have any suitable viscosity depending on factors such as formulated ingredients and purpose of the composition.

Preferred water-soluble film materials for the water-soluble unit dose article of the present disclosure are preferably polymeric materials. The film material can, for example, be obtained by casting, blow-moulding, extrusion or blown extrusion of the polymeric material, as known in the art.

Preferred polymers, copolymers or derivatives thereof suitable for use as pouch material are selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof. Preferably, the level of polymer in the pouch material, for example a PVA polymer, is at least 60%. The polymer can have any weight average molecular weight, preferably from about 1000 to 1,000,000, more preferably from about 10,000 to 300,000 yet more preferably from about 20,000 to 150,000.

Preferably, the water-soluble film comprises polyvinylalcohol polymer, preferably wherein the polyvinylalcohol polymer comprises polyvinyl alcohol homopolymer or polyvinyl alcohol copolymer, or a mixture thereof, preferably a blend of polyvinylalcohol homopolymers and/or polyvinylalcohol copolymers, preferably wherein the polyvinylalcohol copolymers are selected from sulphonated and carboxylated anionic polyvinylalcohol copolymers especially carboxylated anionic polyvinylalcohol copolymers, most preferably wherein the polyvinylalcohol polymer comprises a blend of a polyvinylalcohol homopolymer and a carboxylated anionic polyvinylalcohol copolymer or a blend of polyvinylalcohol homopolymers. Alternatively the water-soluble film may comprise a single polyvinylacohol polymer, preferably a carboxylated anionic polyvinylalcohol copolymer.

Preferred films exhibit good dissolution in cold water, meaning unheated distilled water.

Preferably such films exhibit good dissolution at temperatures of 24° C., even more preferably at 10° C. By good dissolution it is meant that the film exhibits water-solubility of at least 50%, preferably at least 75% or even at least 95%, as measured by the method set out here after using a glass-filter with a maximum pore size of 20 microns, described above.

Preferred films are those supplied by Monosol under the trade references M8630, M8900, M8779, M8310.

### Process of Making

Those skilled in the art will be aware of standard techniques to make the laundry detergent composition and the water-soluble unit dose article according to the present disclosure. Those skilled in the art will also be aware of standard techniques and methods to make the ingredients of the laundry detergent composition of the present disclosure.

### Process of Use

A further aspect of the present disclosure is a process of laundering fabrics comprising the steps of diluting between 200 and 3000 fold, preferably between 300 and 2000 fold, the water-soluble unit dose article according to the present disclosure with water to make a wash liquor, contacting fabrics to be treated with the wash liquor.

Preferably the wash liquor comprises between 5 L and 75 L, preferably between 7L and 40 L, more preferably between 10 L and 20 L of water. Alternatively, the wash liquor may comprise between 35 L and 65 L of water. Preferably, the wash liquor is at a temperature of between 5° C. and 90° C., preferably between 10° C. and 60° C., more preferably between 12° C. and 45° C., most preferably between 15° C. and 40° C. Preferably, washing the fabrics in the wash liquor takes between 5 minutes and 60 minutes, preferably between 5 minutes and 40 minutes, more preferably between 5 minutes and 30 minutes, even more preferably between 5 minutes and 20 minutes, most preferably between 6 minutes and 18 minutes to complete. Alternatively, washing the fabrics in the wash liquor may take between 30 minutes and 60 minutes. Preferably, the wash liquor comprises between 1 kg and 20 kg, preferably between 3 kg and 15 kg, most preferably between 5 and 10 kg of fabrics. The wash liquor may comprise water of any hardness preferably varying between 0 gpg to 40gpg.

### Materials & Methods

### Materials

Lipase variant A: Lipase variant shown in SEQ ID NO: 1
Lipase B: Lipase variant shown in SEQ ID NO: 3
Protease A: Serine protease shown in SEQ ID NO: 4

| Variant | Mutations vs SEQ ID: 1 |
|---|---|
| a | S23G + N27D + I40E + D57N + K60V + G91N + K98E + R108K + Y138A + T143A + G149A + |
| | G156Y + A173S + H198N + I202C + E210F + V228P + P253C + D254S + T256P + L264P |
| b | N11Q + S23G + N27D + I40E + D57N + K60V + G91T + K98E + S105E + R108K + G109A + |
| | V154L + S170T + A173Q + H198N + I202C + E210Q + V228P + P253C + D254S + T256P + L264P |
| c | S23G + N27D + A30N + I40E + D57N + K60V + L75D + G91T + K98E + R108K + G109A + |
| | H198N + T199Q + I202C + E210Q + V228P + P253C + D254S + T256P + L264P |
| d | Q9H + S23G + N27D + I40E + D57N + K60V + G91T + K98E + R108K + G109A + Y138L + |
| | H198N + I202C + E210Q + V228P + P253C + D254S + T256P + L264P |
| e | Q9H + S23G + N27D + I40E + D57N + K60V + G91T + K98E + R108K + G109A + V154L + |
| | H198N + I202C + E210Q + V228P + P253C + D254S + T256P + L264P |

### Construction of Lipase Variants by Site-Directed Mutagenesis

Site-directed variants are constructed of the lipase shown as SEQ ID NO: 1, comprising specific substitutions. The variants are made by traditional cloning of DNA fragments (Sambrook et al., Molecular Cloning: A Laboratory Manual, 2nd Ed., Cold Spring Harbor, 1989) using PCR together with properly designed mutagenic oligonucleotides that introduced the desired mutations in the resulting sequence.

Mutagenic oligos are designed corresponding to the DNA sequence flanking the desired site(s) of mutation, separated by the DNA base pairs defining the insertions/deletions/substitutions, and purchased from an oligo vendor such as Life Technologies.

In order to test the lipase variants, the mutated DNA comprising a variant are integrated into a competent A. oryzae strain by homologous recombination, fermented using standard protocols (yeast extract based media, 3-4 days, 30° C.), and purified by chromatography.

### Compositions of Model Detergents

| | ACTIVE |
|---|---|
| MODEL DETERGENT 1 | CONTENT |
| Llinear alkylbenzene sulfonic acid (LAS acid) | 21.9% |
| Alcohol ethoxylate with 7 mol EO (AEO-7) | 26.1% |
| Topped Palm Kernel Fatty Acid | 9.4% |
| Monoethanol amine (MEA) | 7.0% |
| Glycerol | 8.4% |
| Propylene glycol (MPG) | 15.8% |
| Diethylenetriaminepentakis(methylene)pentakis | 0.5% |
| (phosphonic acid), heptasodium salt (DTPMP Na7) | |
| Water (demineralized) | 10.5% |
| pH target 7.5-8.0 | 8.0 |

| | ACTIVE |
|---|---|
| MODEL DETERGENT 2 | CONTENT |
| Llinear alkylbenzene sulfonic acid (LAS acid) | 20.8% |
| Alcohol ethoxylate with 7 mol EO (AEO-7) | 8.3% |
| Sodium lauryl ether sulfate (SLES) | 14.5% |
| Topped Palm Kernel Fatty Acid | 6.2% |
| Monoethanol amine (MEA) | 6.2% |
| Glycerol | 5.3% |
| Propylene glycol (MPG) | 15.6% |
| Dipropylene glycol (DPG) | 3.1% |
| Diethylenetriaminepentakis(methylene)pentakis | 1.0% |
| (phosphonic acid), heptasodium salt (DTPMP Na7) | |
| Water (demineralized) | 11.3% |
| Ethoxylated polyethylene-polyamine (Sokalan | 7.3% |
| HP 20) | |
| pH target 7.5-8.5 | 8.0 |

### Methods

### pNP Assay for Determination of Lipase Activity

Enzymes can be assayed for lipase activity using the pNP assay described below.

### Principle

The substrate pNP-substrate is hydrolyzed by the lipase under standard conditions. pNP-valerate is used as an example of a saturated short chain fatty acid. Valeric acid as the acyl group may be replaced by a long chain fatty acid such as oleic acid.

Hydrolysis of the pNP-substrate results in a yellow solution, the absorbance of the solution measured at 405 nm is a function of the activity of the lipolytic enzyme.

By varying the pNP substrate the ratio between lipase activity on unsaturated substrates having long fatty acyl chains (e.g. oleic acid) to short acyl chain (e.g. p-nitrophenyl butyrate and/or p-nitrophenyl valerate) can be determined. Variation of substrate may call for adjustment of e.g. buffer system, adjustments that are easily within the purview of the skilled person.

### Lipase Activity

Enzymes are diluted in Buffer

Substrate: The relevant pNP substrate (e.g. pNp-Valerate Sigma N-4377) 1 mM in Buffer prepared from stock-solution 100 mM in Methanol

Buffer: 50 mM TRIS, 0.4% Triton X-100, is prepared to pH 7.7

| STEP | PREPARATION |
|---|---|
| 1 | Substrate-stock is made to 100 mM in Methanol |
| | 112 mg pNp-Valerate in 5 ml Methanol. |
| | This solution must be kept in a dark bottle or wrapped |
| | in aluminium foil to avoid daylight. |
| | The solution is to be kept at −18° C. |
| | Prepare fresh every 2 weeks |
| 2 | Enzymes are diluted to a concentration corresponding to |
| | Vmax <70 mAbs/min |
| 3 | Substrate is prepared: |
| | 0.1 ml pNp-Valerate Stock-solution |
| | 9.9 ml Buffer |
| Step | Assay |
| 1 | Samples: Diluted enzyme 20 microL |
| | pNP-substrate 150 microL |
| 2 | Reference: Buffer 20 microL |
| | pNP-substrate 150 microL |
| | Reference must be included in every assay |
| 3 | The measurement is done as a kinetic measurement at |
| | 405 nm. |
| 4 | Setup: |
| | Wavelength: 405 nm |
| | Time: 10:00 min. |
| | Interval 10 sec. |
| | Reads: 61 |
| | Automix: Once |
| | Lag time: 0 |
| | End time: 10:00 |
| | ODmin.: 0 |
| | ODmax: 2 |
| 5 | Result: Vmax calculated from measurement points |

Results are calculated as:

$$[ V max ( enzyme ) - V max ( buffer ) ] / [ slope of standard curve ]$$

Microtiter plates (Thermo Scientific 269620 96F without lid microwell plate) for plate reader spectrophotometers (Molecular Devices Spectramax 190) can conveniently be used for determination of lipase activity by standard methods based on use of paranitrophenol-esters.

### Active Site Titration (AST Assay)

The concentration of sterile filtered culture supernatants containing lipase variants and purified lipase variants are determined by burst active site titration as described in the following.

The lipase is diluted in 0.01% Triton-X100, if necessary, to get concentration below 5 μM (corresponding to 150 μg enzyme protein/ml). 100 μL purified lipase is mixed with 100 μL of 40 μM resorufin inhibitor (ethyl resorufinyl heptylphosphonate; a lipase inhibitor) dissolved in 0.5 M Tris, 2 mM SDS (Sodium Dodecyl Sulphate), pH 9.0 in the well of a black microtiter plate. Immediately after mixing, kinetics of fluorescence from liberated resorufin is measured every minute for 3 hours (until bursts are finalized) (excitation at 515 nm, emission at 590 nm, measured on a FLUOstar OMEGA fluorescence intensity measuring instrument from BMG LabTechnologies GmbH).

Measured fluorescence values are fitted to the equation:

$$F = F 0 + Burst * ( 1 - exp ( - ( t + dt ) * ln ( 2 ) / {T}^{1 / 2} ) + Slope * ( t + dt )$$

where F is the measured fluorescence, FO is the fluorescence background from inhibitor and lipase, t is the time since first fluorescence measurement, dt is the time from mixing of lipase with inhibitor to the first fluorescence measurement, Burst is the fluorescence burst, T½ is the half-life time for the exponential burst, and Slope is the slope for the linear change in fluorescence, e.g. due to hydrolysis of lipase-ethyl heptylphosphonate complex and/or bleaching of resorufin. The active lipase concentration is determined as the ratio between the calculated burst and the slope of a resorufin standard curve (0-4 uM; included on the microtiter plate).
Concentration Determination from A280

The concentration of the purified lipase variants is also estimated from the absorbance at 280 nm using the extinction coefficient 1.24 A280/mg.

### Storage Stability Assay for Lipase Variants

Sterile filtered culture supernatants containing lipase variants and purified lipase samples are diluted to 0.1 and 0.05 mg/ml with 0.01% Triton X-100 based on concentrations determined by Active Site Titration (AST assay). Samples with concentrations below 0.1 mg/ml (high concentration) are used undiluted and two times diluted (low concentration).

Each lipase variant is tested in a well with the high enzyme concentration and a well with the low concentration. In the wells of a microtiter plate (called detergent plate, Nunc U96 PP 0.5 ml) 15 μl diluted lipase sample is mixed with either 285 μl concentrated Model Detergent 2 with 0.3% sodium bisulfite (Sigma 243973) added or with 285 μl Model Detergent 1 with 240 ppm Protease A added, using a magnetic bar. After mixing the detergent plate is incubated at 40° C. or 45° C. in a Biosan PST-100HL thermomixer.

After various incubation times (e.g. 0, 3, 24, 48, 72 and 168 hours) residual lipase activity is measured. 10 μl from the detergent plate is mixed with 190 μl assay buffer (0.1 M Hepes, 0.2% Triton X-100, pH 8). In a black microtiter plate (Nunc F) 20 μl of this dilution is mixed with 80 μl assay buffer. After addition of 100 μl substrate solution (125 μM 4-methylumbelliferyl oleate (Sigma 75164) in assay buffer) and mixing, fluorescence is read every 10 seconds for 5 minutes (excitation at 372 nm, emission at 445 nm, Biotek Synergy H1 microplate reader). Activity is determined from the initial slope of fluorescence increase by linear regression.

Decrease in activity during incubation with detergent is assumed to be exponential. Half-life (T½) is found from linear regression of logarithm of activity versus incubation time.

All variants where the half-life (T1/2) was measured under the same conditions are compared to each other. The mutational difference between variant 1 (Var1) and variant 2 (Var2) is determined. The improvement factor (IF) for this mutational difference is calculated as ratio of the half-life of variant 1 and the half-life of variant 2. If the variant is measured multiple times a median is calculated.

In the Examples the Improvement Factor (IF) is determined as:

$$IF = \frac{half - life variant 1}{half - life variant 2}$$

### Test Conditions:

Model Detergent 1, 45° C., 240 ppm Protease A
Model detergent 2, 40° C., 0.3% w/v sodium bisulfite

### Detergent Stability Assay for Lipase Variants

Each lipase variant, expressed in A. oryzae, is grown in four independent biological replicates in separate microtiter plates in defined media, for 4 days at 37° C. in 96-well lidded MTP's without agitation.

Stability test is performed by incubating the variants in detergent for different length of time and temperature, and other additives depending on the stability of parent lipase and comparing the activity against control plate which is incubated at 4° C. for the same duration.

The absolute activity is measured by using the kinetic activity measured by the increase in fluorescence derived by the hydrolysis of 4-methylumbelliferyl oleate. The detergent-incubated enzyme is diluted, substrate added, and the plate is read immediately using a Tecan Synergy2 using fluorescence measurements settings of λex 372 nm; λem 445 nm for 12 min. The output is saved (Vmax, R2) and used for calculating residual activity, half-life (T½), and initial activity, for data that passed quality filters. The residual activity is calculated by taking the ratio of the response from samples on the stressed plate compared to the response of the control plate, and expressing in terms of % RA, which is then used to calculate the half-life.

Half-life is calculated by the equation:

$$\frac{Ln ( 0.5 )}{( \frac{Ln ( RA )}{t} )}$$

where t=incubation time in hours, and Half-life is defined as hours.

Half-life Improvement Factor (HIF) is calculated by taking the Half-life ratio of the sample variant to the reference lipase, which are also grown on the replicate microtiter plate. Reference lipase was either SEQ ID NO: 1 or SEQ ID NO: 3.

In the Examples the HIF is determined as:

$$Half - life Improvement Factor ( HIF ) = \frac{value Var 1}{value Var 2}$$

### Test Conditions:

1. Model Detergent 1, 38° C., 240 ppm Protease A, 48 hours incubation
2. Model Detergent 2, 37° C., 0.3% w/v sodium bisulfite, 24 hours incubation
3. Model Detergent 2, 43° C., 0.3% w/v sodium bisulfite, 24 hours incubation
4. Model Detergent 2, 43.5° C., 0.3% w/v sodium bisulfite, 24 hours incubation

All variants measured under the same conditions and where the HIF was calculated towards the same reference are compared to each other. The mutational difference between variant 1 (Var1) and variant 2 (Var2) is determined. The improvement factor (IF) for this mutational difference is calculated as the ratio of the HIF of variant 1 and the HIF of variant 2. If the variant is measured multiple times a median is calculated.

In the Examples the IF is determined as:

$$Improvement factor ( IF ) IF = \frac{HIF variant 1}{HIF variant 2}$$

### EXAMPLES

The present disclosure is further described by the following examples that should not be construed as limiting the scope of the disclosure.

### Example 1

### Determination of the Storage Stability for Lipase B and Lipase A

The half-life (T_{1/2}) was determined using the “Storage Stability Assay” described in the “Materials & Methods” section.

| | T_{1/2} | | T_{1/2} |
|---|---|---|---|
| | (HOURS) | | (HOURS) |
| | MODEL | T_{1/2} | MODEL |
| | DETERGENT 1 | (HOURS) | DETERGENT 2 |
| | 240 PPM | MODEL | 0.3% SODIUM |
| | PROTEASE A | DETERGENT 1 | BISULFITE |
| | T = 40° C. | T = 40° C. | T = 40° C. |
| Lipase B | 15.18 | 67.27 | 61.15 |
| (SEQ ID | | | |
| NO: 3) | | | |
| Lipase A | 4.24 | 21.27 | 1.78 |
| (SEQ ID | | | |
| NO: 1) | | | |

### Example 2

### Determining Detergent Stability of Mutations in SEO IL) NO: 1

The “Detergent Stability Assay” described in the “Materials & Methods”-section was used to determine the Half-life improvement factor (HIF) towards SEQ ID NO: 1 and then the Improvement Factor (IF) between pairs of variants.

Conditions: Model Detergent 2, 37° C., 0.3% w/v sodium bisulfite, 24 hours incubation.

| | DIFFERENCE | MUTATIONS | | MUTATIONS | |
|---|---|---|---|---|---|
| EFFECT OF | BETWEEN | IN VAR1 | | IN VAR2 | |
| MUTATIONS | VAR1 AND | COMPARED TO | VAR1 | COMPARED TO | VAR2 |
| (IF) | VAR2 | SEQ ID NO: 1 | (HIF) | SEQ ID NO: 1 | (HIF |
| 4.8 | I202C + P253C | I202C P253C | 4.8 | | 1.0 |

### Example 3

### Determinization Detergent Stability for Mutations in SEO ID NO: 3

The “Detergent Stability Assay” described in the “Materials & Methods”-section was used to determine the Half-life improvement factor (HIF) towards SEQ ID NO: 3 and then the Improvement Factor (IF) between pairs of variants.

Conditions: Model Detergent 2, 43° C., 0.3% w/v sodium bisulfite, 24 hours incubation

| | DIFFERENCE | MUTATIONS | | MUTATIONS | |
|---|---|---|---|---|---|
| EFFECT OF | BETWEEN | IN VAR1 | | IN VAR2 | |
| MUTATIONS | VAR1 AND | COMPARED TO | VAR1 | COMPARED TO | VAR2 |
| (IF) | VAR2 | SEQ ID NO: 1 | (HIF) | SEQ ID NO: 1 | (HIF |
| 7.6 | H198N + | S23G N27D I40E | 2.6 | S23G N27D I40E | 0.3 |
| | I202C + P253C | D57N K60V G91T | | D57N K60V G91T | |
| | | K98E R108K | | K98E R108K | |
| | | H198N I202C | | E210Q S224N | |
| | | E210Q S224N | | V228P D254S | |
| | | V228P P253C | | T256P | |
| | | D254S T256P | | | |

### Example 4

### Determination of Half-Life for Mutations in SEO ID NO: 1

The “Storage Stability Assay” described in the “Materials & Methods”-section was used to determine the half-life (T_{1/2}) in hours.

Conditions: Model Detergent 1 45° C. 240 m Protease A.

| MUTATIONS COMPARED TO SEQ ID NO: 1 | T_{1/2} |
|---|---|
| S23G + N27D + I40E + D57N + K60V + G91T + K98E + | 13.98 |
| R108K + H198N + I202C + E210Q + V228P + P253C + | |
| D254S + T256P | |

### Example 5

### Determination of Half-Life for Mutations in SEO ID NO: 1

The “Storage Stability Assay” described in the “Materials & Methods”-section was used to determine the half-life (T_{1/2}) in hours.

Conditions: Model detergent 2, 40° C., 0.3% sodium bisulfite.

| MUTATIONS COMPARED TO SEQ ID NO: 1 | T_{1/2} |
|---|---|
| S23G + N27D + I40E + D57N + K60V + G91T + K98E + | 63.15 |
| R108K + H198N + I202C + E210Q + V228P + P253C + | |
| D254S + T256P | |

### Example 6

### Determination of Half-Life for Mutations in SEO ID NO: 1

The “Storage Stability Assay” described in the “Materials & Methods”-section was used to determine the half-life (T_{1/2}) in hours of purified variants.

Conditions: Model Detergent 1, 45° C., 240 m Protease A.

| MUTATIONS COMPARED TO SEQ ID NO: 1 | T½ |
|---|---|
| S23G + N27D + I40E + D57N + K60V + G91N + K98E + R108K + Y138A + T143A + G149A + | 43.35 |
| G156Y + A173S + H198N + I1202C + E210F + V228P + P253C + D254S + T256P + L264P (Variant a) | |
| N11Q + S23G + N27D + I40E + D57N + K60V + G91T + K98E + S105E + R108K + G109A + V154L + | 45.41 |
| S170T + A173Q + H198N + I202C + E210Q + V228P + P253C + D254S + T256P + L264P (Variant b) | |
| S23G + N27D + A30N + I40E + D57N + K60V + L75D + G91T + K98E + R108K + G109A + | 49.55 |
| H198N + T199Q + I202C + E210Q + V228P + P253C + D254S + T256P + L264P (Variant c) | |
| Q9H + S23G + N27D + I40E + D57N + K60V + G91T + K98E + R108K + G109A + Y138L + H198N + | 19.69 |
| I202C + E210Q + V228P + P253C + D254S + T256P + L264P (Variant d) | |
| Q9H + S23G + N27D + I40E + D57N + K60V + G91T + K98E + R108K + G109A + V154L + | 25.78 |
| H198N + I202C + E210Q + V228P + P253C + D254S + T256P + L264P (Variant e) | |

### Example 7

### Determination of Half-Life for Mutations in SEO ID NO: 1

The “Storage Stability Assay” described in the “Materials & Methods”-section was used to determine the half-life (T_{1/2}) in hours of purified variants.

Conditions: Model detergent 2, 40° C., 0.3% sodium bisulfite.

| MUTATIONS COMPARED TO SEQ ID NO: 1 | T_{1/2} |
|---|---|
| S23G + N27D + I40E + D57N + K60V + G91N + K98E + R108K + Y138A + T143A + G149A + | 1314.02 |
| G156Y + A173S + H198N + I202C + E210F + V228P + P253C + D254S + T256P + L264P | |
| (Variant a) | |
| N11Q + S23G + N27D + I40E + D57N + K60V + G91T + K98E + S105E + R108K + G109A + | 793.51 |
| V154L + S170T + A173Q + H198N + I202C + E210Q + V228P + P253C + D254S + T256P + | |
| L264P (Variant b) | |
| S23G + N27D + A30N + I40E + D57N + K60V + L75D + G91T + K98E + R108K + G109A + | 903.10 |
| H198N + T199Q + I202C + E210Q + V228P + P253C + D254S + T256P + L264P | |
| (Variant c) | |
| Q9H + S23G + N27D + I40E + D57N + K60V + G91T + K98E + R108K + G109A + Y138L + | 132.58 |
| H198N + I202C + E210Q + V228P + P253C + D254S + T256P + L264P (Varaint d) | |
| Q9H + S23G + N27D + I40E + D57N + K60V + G91T + K98E + R108K + G109A + V154L + | 421.22 |
| H198N + I202C + E210Q + V228P + P253C + D254S + T256P + L264P (Variant e) | |

### Example 8

Determination of Stain Removal Performance for Mutations in SEO ID NO: 1 The impact of mutations compared to SEQ ID NO: 1 has been tested on stain removal performance using an automated tergotometer.

### Wash Test Procedure Using an Automated Tergotometer

1. 1 litre of 8 US grains per gallon (gpg) hard water was heated to 27° C. and added to each tergotometer pot.

2. 0.54g of base detergent were added to the automated tergotometer (Hahn Automation, Washington, United Kingdom) wash pots, followed by addition of the lipase variants at a level of 0.15 ppm active enzyme in the wash.

3. 4 swatches (5×5 cm) of grease stains were added to the tergotometer pot (2 swatches per each stain type: Solvent Violet 13 lard and Sudan Red lard), followed by the addition of 5×5 cm knitted cotton ballast (supplied by Warwick Equest, Consett, United Kingdom) to give a total load weight of 60 g fabrics. The grease stains were prepared in-house on Equest knitted cotton using the following procedure:
Solvent Violet 13 Lard—0.008% SV13 dye added to Asda lard at 75C and mixed in for 30 mins, 200 μL of the SV13 lard is then added to each 5×5 cm fabric and to dry for 60 mins before being placed in a 60C oven for 60 mins, and then being left for 48 hours before being used.
Sudan Red 7B lard—same procedure as SV13 lard but Sudan Red 7B dye is used instead of Solvent Violet 13 dye.

4. The tergotometer was set to mix at 208 RPM for 17 minutes to simulate a main wash process.

5. Wash water was then removed and the fabrics were spun at 1000 rpm for ~1 min.

6. 1 litre of 8 grains per gallon (gpg) water at 15° C. was then added to each pot and the tergotometer was set to mix at 208 RPM for 5 minutes to simulate a rinse process.

7. Rinse water was then removed and the fabrics were spun at 1000 rpm for ~1 min.

8. All fabrics were then removed from each pot.

9. Steps 1-8 were repeated a further 3 times.

10. The stained tracers were separated from wash ballast and left to air dry overnight.

11. Dried stains were evaluated for stain removal using L*a*b* readings taken using a DigiEye (VeriVide Ltd, Leicester, UK) at shutter speed ½, Aperture 8 which was calibrated before use. L*a*b* measurements were taken for unwashed stains, washed stains and unsoiled fabric, and Delta E* calculations made to determine the level of staining for both unwashed stains and washed stains compared to the unsoiled fabric using the following equation where the suffix 1 denotes the values for the unsoiled fabric and the suffix 2 denotes the values for the unwashed or washed stains.

$$Δ {E}_{A B}^{*} = \sqrt{{( {L}_{2}^{*} - {L}_{1}^{*} )}^{2} + {( {a}_{2}^{*} - {a}_{1}^{*} )}^{2} + {( {b}_{2}^{*} - {b}_{1}^{*} )}^{2}}$$

The Stain Removal Index (SRI) is the level of stain removal calculated as a percentage as follows: SRI=100×(A−B)/A

Where:
A=Delta E* of Unwashed fabric stained region
B=Delta E* of Washed fabric stained region.

### Test Formulations:

The base detergent used for stain removal testing is shown in the table below.

| As 100% active | Base Detergent |
|---|---|
| Total surfactant | 45.3 |
| Water | 11.0 |
| Nonionic surfactant 1 ¹ | 4.1 |
| Nonionic surfactant 2 ² | 6.1 |
| HLAS | 27.0 |
| H-C1215-AE2.5S | 7.9 |
| Topped Coconut Fatty acid | 6.6 |
| Citric acid | 1.3 |
| 1,2-Propanediol | 14.2 |
| Glycerol | 2.5 |
| Monoethanolamine | 8.4 |
| Amphiphilic graft polymer³ | 2.5 |
| ethoxylated polyethyleneimine⁴ | 4.3 |
| GLDA chelant | 0.9 |
| Sodium Bisulfite | 0.4 |
| Hydrogenated Castor Oil | 0.09 |
| Enzyme (Protease, amylase, mananase, | 0.16 |
| phosphodiesterases) | |
| Sodium Formate | 0.14 |
| Brightener 49 | 0.1 |
| Perfume, dyes and minors | Balance to |
| | 100% |

¹ Neodol C14-15 EO7, available from the Shell Company
² Natural derived C12-14 EO9
³polyethylene glycol graft polymer comprising a polyethylene glycol backbone (Pluriol E6000) and hydrophobic vinyl acetate side chains, comprising 40% by weight of the polymer system of a polyethylene glycol backbone polymer and 60% by weight of the polymer system of the grafted vinyl acetate side chains
⁴ethoxylated polyethyleneimine having an average degree of ethoxylation of 20 per EO chain and a polyethyleneimine backbone with MW of about 600

### Stain Removal Data

| | % Stain | | % Stain | | | |
|---|---|---|---|---|---|---|
| | Removal | Standard | Removal | Standard | | Index Vs |
| | SR Lard | Error | SV13 Lard | Error | Average | SEQ: 1 |
| Base Detergent | 33.65 | 1.48 | 38.64 | 2.06 | 36.15 | 89 |
| SEQ ID: 1 | 38.16 | 1.43 | 43.15 | 1.87 | 40.66 | 100 |
| Variant a | 36.90 | 0.81 | 41.70 | 0.89 | 39.30 | 97 |
| Variant b | 40.31 | 1.61 | 44.70 | 1.48 | 42.51 | 105 |
| Variant c | 40.12 | 1.45 | 42.88 | 1.12 | 41.5 | 102 |
| Variant d | 39.99 | 0.28 | 44.72 | 0.55 | 42.36 | 104 |
| Variant e | 38.62 | 1.34 | 44.43 | 2.09 | 41.53 | 102 |

Variants a-e, according to the present disclosure, provide good stain removal in addition to improved stability.

### Example 9

### Determination of Malodour for Mutations in SEO ID NO: 1

The impact of mutations compared to SEQ ID NO: 1 has been tested for malodour generation using an automated tergotometer.

### Wash Test Procedure Using an Automated Tergotometer

1. 1 litre of 8 US grains per gallon (gpg) hard water was heated to 27° C. and added to each tergotometer pot.

5. 0.54g of base detergent (as disclosed in Example 8) were added to the automated tergotometer (Hahn Automation, Washington, United Kingdom) wash pots, followed by addition of the lipase variants at a level of 0.15 ppm active enzyme in the wash.

3. 3 swatches (5×5 cm) of butter stains (KCS-10, Center for Test materials, Vlaardingen, Netherlands) were included in each tergotometer pot followed by the addition of 5×5 cm knitted cotton ballast (supplied by Warwick Equest, Consett, United Kingdom) to give a total load weight of 60 g fabrics.

4. The tergotometer was set to mix at 208 RPM for 17 minutes to simulate a main wash process.

5. Wash water was then removed and the fabrics were spun at 1000 rpm for ~1 min.

6. 1 litre of 8 grains per gallon (gpg) water at 15° C. was then added to each pot and the tergotometer was set to mix at 208 RPM for 5 minutes to simulate a rinse process.

7. Rinse water was then removed and the fabrics were spun at 1000 rpm for ~1 min.

8. All fabrics were then removed from each pot.

9. Steps 1-8 were repeated a further 3 times.

10. The stained tracers were separated from wash ballast and left to air dry for 24 hours.

11. The test swatches are then placed in a 200 ml plastic cup with a sealed lid at 30C for 24 hours before being graded by experienced malodour panelists on a scale from 0 (no foreign odour) to 10 (extremely strong foreign odour).

| | Average | |
|---|---|---|
| | Malodour Grade | Standard Error |
| Base Detergent | 0 | 0 |
| SEQ ID: 1 | 3 | 0 |
| Variant a | 3 | 0.5 |
| Variant b | 3.25 | 0.25 |
| Variant c | 3.5 | 0.5 |
| Variant d | 3.25 | 0.25 |
| Variant e | 2.75 | 0.25 |
| SEQ ID: 2 with | 5.5 | 0.5 |
| T231R and N233R | | |
| (Outside the scope | | |
| of the claims) | | |

Variants a-e, according to the present disclosure, present acceptable odor profile in addition to improved stability.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A liquid laundry detergent composition, wherein the liquid laundry detergent composition comprises:
i) from about 5% to about 45% by weight of the liquid laundry detergent composition of linear alkylbenzene sulfonate;
ii) a variant of a parent lipase which has lipase activity, and has at least about 60%, but less than 100% sequence identity with SEQ ID NO: 1 or SEQ ID NO: 2 and comprises the following substitutions: I202C+P253C, using SEQ ID NO: 1 for numbering; and
iii) from about 2% to about 60% by weight of the liquid laundry detergent composition of water.

2. A liquid laundry detergent composition according to claim 1, wherein the variant has at least about 70% sequence identity with SEQ ID NO: 1, using SEQ ID NO: 1 for numbering.

3. A liquid laundry detergent composition according to claim 1, wherein the variant comprises one or more of the following substitutions S23G, N27D, I40E, D57N, K60V, G91T, K98E, R108K, H198N, I202C, E210Q, V228P, P253C, D254S, T256P, L264P, using SEQ ID NO: 1 for numbering.

4. A liquid laundry detergent composition according to claim 1, comprising at least two or more of the following substitutions: S23G, N27D, I40E, D57N, K60V, G91T, K98E, R108K, H198N, I202C, E210Q, V228P, P253C, D254S, T256P, L264P, using SEQ ID NO: 1 for numbering.

5. A liquid laundry detergent composition according to claim 1 wherein the variant comprises or consists of substitutions corresponding to the following set of substitutions, using SEQ ID NO: 1 for numbering:
S23G+N27D+I40E+D57N+K60V+G91T+K98E+R108K+H198N+I202C+E210Q+V228 P+P253C+D254S+T256P
S23G+N27D+I40E+D57N+K60V+G91N+K98E+R108K+Y138A+T143A+G149A+G15
6Y+A173S+H198N+I202C+E210F+V228P+P253C+D254S+T256P+L264P
N11Q+S23G+N27D+I40E+D57N+K60V+G91T+K98E+S105E+R108K+G109A+V154
L+S170T+A173Q+H198N+I202C+E210Q+V228P+P253C+D254S+T256P+L264P
S23G+N27D+A30N+I40E+D57N+K60V+L75D+G91T+K98E+R108K+G109A+H198N +T199Q+I202C+E210Q+V228P+P253C+D254S+T256P+L264P
Q9H+S23G+N27D+I40E+D57N+K60V+G91T+K98E+R108K+G109A+Y138L+H198N +I202C+E210Q+V228P+P253C+D254S+T256P+L264P
Q9H+S23G+N27D+I40E+D57N+K60V+G91T+K98E+R108K+G109A+V154L+H198N +I202C+E210Q+V228P+P253C+D254S+T256P+L264P.

6. A liquid laundry detergent composition according to claim 1, wherein the liquid laundry detergent composition comprises a protease.

7. A liquid laundry detergent composition according to claim 1, wherein the liquid laundry detergent composition comprises a reducing agent preferably selected from the group consisting of sodium sulphite, calcium sulphite, potassium sulphite, magnesium sulphite, bisulphite, sodium bisulphite, calcium bisulphite, potassium bisulphite, magnesium bisulphite, and a mixture thereof.

8. A liquid laundry detergent composition according to claim 1 wherein the detergent composition comprises from about 0.01% to about 1% by weight of the liquid laundry detergent composition of the reducing agent.

9. A liquid laundry detergent composition according to claim 1, wherein the liquid laundry detergent composition comprises an alkoxylated alkyl sulphate.

10. A liquid laundry detergent composition according to claim 1, wherein the liquid laundry detergent composition comprises a non-ionic surfactant.

11. A liquid laundry detergent composition according to claim 1, wherein the liquid laundry detergent composition comprises an additional enzyme selected from the group consisting of alginate lyase, aminopeptidase, amylase, carbohydrase, carboxypeptidase, catalase, cellulase, chitinase, cutinase, glycosyltransferase, esterase, alpha-galactosidase, beta-galactosidase, glucoamylase, alpha-glucosidase, beta-glucosidase, haloperoxidase, hexosaminidase, invertase, laccase, lipase, mannanase, mannosidase, nuclease, oxidase, pectinolytic enzyme, peptidoglutaminase, peroxidase, phytase, polyphenoloxidase, proteolytic enzyme, transglutaminase, xylanase, xanthan lyase, xanthanase, endo-β 1,3-glucanase and mixtures thereof, preferably the liquid laundry detergent composition comprises a protease, an amylase and an additional enzyme selected from the group consisting cellulase, lipases, xyloglucanases, mannanases, nucleases, pectate lyases, and a mixture thereof.

12. A liquid laundry detergent composition according to claim 1, wherein the liquid laundry detergent composition comprises a cleaning adjunct selected from the group consisting of: anti-redeposition agents, neutralizers, optical brighteners, foam inhibitors, chelators, bittering agents, dye transfer inhibitors, soil release agents, water softeners, electrolytes, pH regulators, anti-graying agents, anti-crease components, colorants, scents, processing aids, and mixtures thereof.

13. A liquid laundry detergent composition according to claim 1, wherein the liquid laundry detergent composition comprises:
a. a cationic polysaccharide; and/or
b. an alkoxylated polyethyleneimine.

14. A liquid laundry detergent composition according to claim 1, wherein the liquid laundry detergent composition comprises an organic solvent selected from the group consisting of: 1,2-propanediol, dipropylene glycol, tripropyleneglycol, glycerol, sorbitol, polyethylene glycol, ethoxylated glycerin, and a mixture thereof.

15. A liquid laundry detergent composition according to claim 1, wherein the liquid laundry detergent composition has a pH of from about 6 to about 10 as measured in 10% by weight water solution at 25° C.

16. A water-soluble unit dose article comprising a water-soluble film and a liquid laundry detergent composition according to claim 1, wherein the water-soluble film preferably comprises polyvinylalcohol.

17. A process of washing fabrics comprising the steps of contacting the liquid laundry detergent composition or unit dose article according to claim 16 with water such that the liquid laundry detergent composition is diluted in water, contacting fabrics with said wash liquor and optionally rinsing the fabric.


SEQUENCE LISTING (4 sequences)

SEQ ID NO: 1 - protein, 269 aa, synthetic construct
EVSQDLFNQFNLFAQYSAAAYCSKNNNAPAGTNITCTGNICPEVEKADATILYSFRDSGKGDVTGFLALDNTNKLIVLSFRGSRSIENWIGNLNFDLKEINDICSGCRGHDGFTSSWFSVADTLRQKVEDAVREHPDYRVVFTGHSLGGALATVAGADLRGNGYDIDVFSYGAPRVGNRAFAEFLTVQTGGTLYRITHTNDIVPRLPPREFGYSHSSPEYWIKSGTLVPVRRRDIVKIEGIDAEGGNNQPNIPDITAHLWYFGLIGTCL

SEQ ID NO: 2 - protein, 269 aa, Thermomyces lanuginosus [sequence omitted]

SEQ ID NO: 3 - protein, 269 aa, synthetic construct
EVSQDLFNQFNLFAQYSAAAYCGKNNDAPAGTNITCTGNECPEVEKADATILYSFRNSGVGDVTGFLALDNTNKLIVLSFRGSRSIENWITNLNFDLEEINDICSGCKGHDGFTSSWFSVADTLRQKVEDAVREHPDYRVVFTGHSLGGALATVAGADLRGNGYDIDVFSYGAPRVGNRAFAEFLTVQTGGTLYRITNTNDCVPRLPPRQFGYSHSSPEYWIKSGTLPPVRRRDIVKIEGIDAEGGNNQPNICSIPAHLWYFGLIGTCL

SEQ ID NO: 4 - protein, 269 aa, synthetic construct
AQSVPWGIERVQAPAAHNRGLTGSGVKVAVLDTGISTHPDLRIRGGASFVPGEPSTQDGNGHGTHVAGTIAALDNSIGVLGVAPSAELYAVKVLGASGSGSVSSIAQGLEWAGNNGMHVANLSLGSPSPSATLEQAVNSATSRGVLVVAASGNSGAGSISYPARYANAMAVGATDQNNNRASFSQYGAGLDIVAPGVNILSTWPGSTYASLNGTSMATPHVAGAAALVKQKNPSWSNVQIRNHLKNTATSLGDTWEYGSGLVNAEAATR